(19) United States
(12) Patent Application Publication
(10) Pub. No.: US 2015/0339717 A1
(43) Pub. Date: Nov. 26, 2015

(54) IDENTIFYING CONTENT ITEMS ASSOCIATED WITH A MAPPING INTERFACE

(71) Applicants: Arnold BINAS, Kirribilli (AU); Jordan BAYLISS-McCULLOCH, Waterloo (AU)

(72) Inventors: Arnold BINAS, Kirribilli (AU); Jordan BAYLISS-McCULLOCH, Waterloo (AU)

(73) Assignee: Google Inc., Mountain View, CA (US)

(21) Appl. No.: 13/597,109

(22) Filed: Aug. 28, 2012

(51) Int. Cl. G06Q 30/02

(52) U.S. Cl. CPC G06Q 30/0261; G06Q 30/0269; G06Q 30/0277

(57) ABSTRACT

Systems, methods, and machine-readable media for generating a textual representation of points of interest (POIs) in a geographic area. The system may be configured to identify a plurality of points of interest (POIs) in a geographic area displayed in a mapping interface, calculate a rank score for each POI of the plurality of POIs in the geographic area based on POI information for each POI, generate a textual representation of the mapping interface based on the rank scores for the plurality of POIs, and submit the textual representation of the geographic area to an advertisement generator, wherein the advertisement generator is configured to select at least one advertisement associated with the geographic area to present to a user.

### FIELD

The present disclosure generally relates to the display of information in a user interface.

### BACKGROUND

Many companies derive revenue from selling space for content items such as advertisements (“ads”). The space being sold may be in traditional media, such as television, radio, newspaper, and magazines, as well as interactive media, such as the Internet.

To reach a more responsive audience, advertisers and sellers of ad space have used various ways (e.g., demographic studies) to target particular ads to particular audiences. In the case of online advertising, certain systems may be configured to analyze text on a web page and determine which ads to show based on that text.

### SUMMARY

Various aspects of the subject technology relate to a system for generating a textual representation of points of interest (POIs) in a geographic area. The system may include one or more processors and a machine-readable medium comprising instructions stored therein, which when executed by the one or more processors, cause the one or more processors to perform operations. The operations may include identifying a plurality of points of interest (POIs) in a geographic area displayed in a mapping interface, each POI having corresponding POI information, calculating a rank score for each POI of the plurality of POIs in the geographic area based on the POI information for each POI, and selecting a subset of the plurality of POIs in the geographic area based on the rank scores for the plurality of POIs. The operations may further include determining, for each POI in the selected subset, a tag to associate with the POI based on the rank score for the POI, generating a textual representation of the geographic area displayed in the mapping interface, wherein the textual representation comprises, for each POI in the selected subset, a reference to the POI and the tag associated with the POI, and submitting the textual representation of the geographic area to a content generator, wherein the content generator is configured to select, from a content repository, at least one content item associated with the geographic area.

Various aspects of the subject technology relate to a computer-implemented method for generating a textual representation of points of interest (POIs) in a geographic area. The method may include identifying a plurality of points of interest (POIs) in a geographic area displayed in a mapping interface, each POI having corresponding POI information, calculating a rank score for each POI of the plurality of POIs in the geographic area based on the POI information for each POI, selecting a subset of the plurality of POIs in the geographic area based on the rank scores for the plurality of POIs, determining, for each POI in the selected subset, a tag to associate with the POI based on the rank score for the POI, generating a textual representation of the geographic area displayed in the mapping interface, wherein the textual representation comprises, for each POI in the selected subset, a reference to the POI and the tag associated with the POI, and submitting the textual representation of the geographic area to a content generator, wherein the content generator is configured to select, from a content repository, at least one content item associated with the geographic area.

Various aspects of the subject technology relate to a machine-readable medium including instructions stored therein, which when executed by a machine, cause the machine to perform operations for generating a textual representation of points of interest (POIs) in a geographic area. The operations may include identifying a plurality of points of interest (POIs) in a geographic area displayed in a mapping interface, each POI having corresponding POI information, calculating a rank score for each POI of the plurality of POIs in the geographic area based on the POI information for each POI, generating a textual representation of the mapping interface based on the rank scores for the plurality of POIs, and submitting the textual representation of the geographic area to an advertisement generator.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed aspects and together with the description serve to explain the principles of the disclosed aspects.

FIG. 1 is a block diagram illustrating an example network environment in which one or more content items associated with a mapping interface may be identified and provided to a user, in accordance with one aspect of the subject technology.

FIG. 2 is a user interface illustrating an example mapping interface, in accordance with one aspect of the subject technology.

FIG. 3 is a conceptual block diagram illustrating an example system for generating a textual representation of points of interest in a geographic area, in accordance with one aspect of the subject technology.

FIG. 4 is an illustration of an example point of interest (POI) database, in accordance with one aspect of the subject technology.

FIG. 5 is a flow chart illustrating an example process for presenting content items associated with a geographic area in a mapping interface, in accordance with various aspects of the subject technology.

FIG. 6 is a block diagram illustrating a computer system with which any of the clients, servers, computing devices, or systems described herein may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

Various aspects of the subject technology involve identifying one or more content items (e.g., advertisements) associated with a mapping interface. Once the content items are identified, they may be displayed to a user along with the mapping interface. To this end, systems known as content generators (e.g., ad generators) may be configured to identify and provide content items (e.g., advertisements) that are related to text that appears on a user interface. For example, when a user views a web page on a browser, an ad generator may be configured to analyze the text on the web page, determine one or more keywords associated with the user interface, and select content items (e.g., advertisements) related to those identified keywords to be displayed to the user. However, the content generators may be unable to select content items based on non-textual components on a web page or other user interface, such as a mapping interface that displays an image of a map of a geographic area.

In accordance with one aspect of the subject technology, a system may be configured to identify a number of points of interest (POIs) in a geographic area displayed in a mapping interface. Each point of interest may be, for example, a business, a landmark, a neighborhood, or any other location.

The system may calculate a rank for each POI identified and generate a textual representation of the mapping interface based on the identified POI and its respective rank. After the textual representation of the mapping interface is generated, it may be submitted to a content generator to be used to select content items (e.g., advertisements) associated with the mapping interface that may be displayed to a user along with the mapping interface.

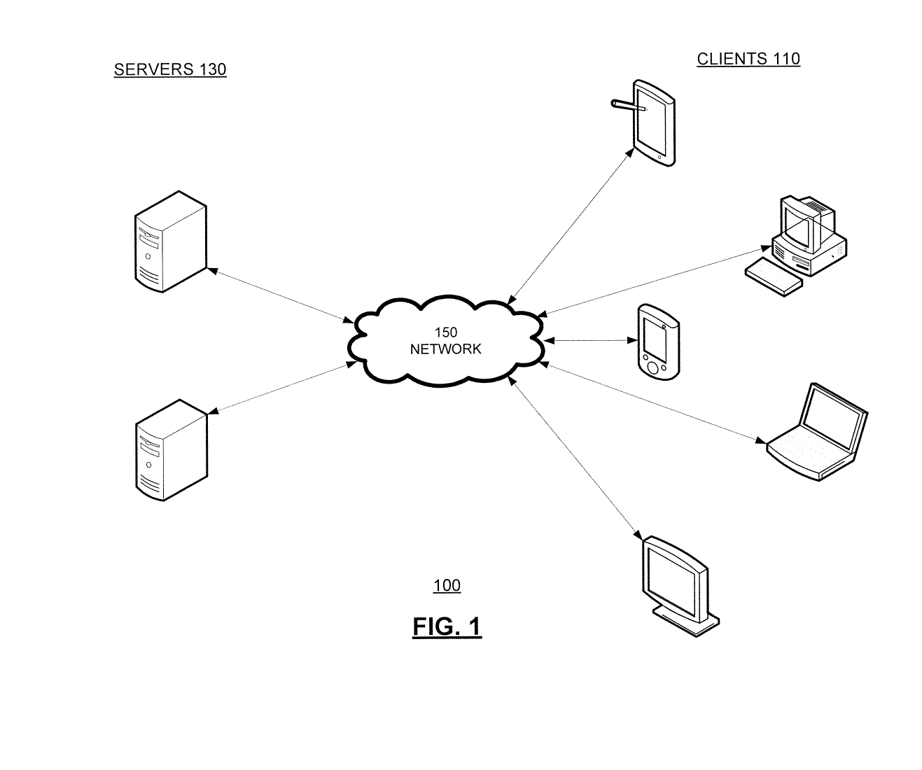

FIG. 1 is a block diagram illustrating an example network environment 100 in which one or more content items associated with a mapping interface may be identified and provided to a user, in accordance with one aspect of the subject technology. The architecture includes one or more servers 130 and clients 110 connected over a network 150 such as the Internet. Although FIG. 1 illustrates a client-server network environment 100, other aspects of the subject technology may include other configurations including, for example, peer-to-peer environments or single system environments.

The clients 110 may include, for example, desktop computers, mobile computers, tablet computers, mobile devices (e.g., a smart phone or a global positioning system (GPS) device), set top boxes (e.g., for a television), video game consoles, thin clients, televisions with one or more processors embedded therein and/or coupled thereto, or any other devices having appropriate processor, memory, and communications capabilities. The clients 110 may be configured to run applications (e.g., a GPS program, a routing application, a web browser, etc.) with a display that may show a mapping interface (e.g., map including various points of interest) to a user. For example, a client machine may request a mapping interface (e.g., a webpage containing a viewport) displaying a portion of a map in order to locate a particular place or find a route from one location to another.

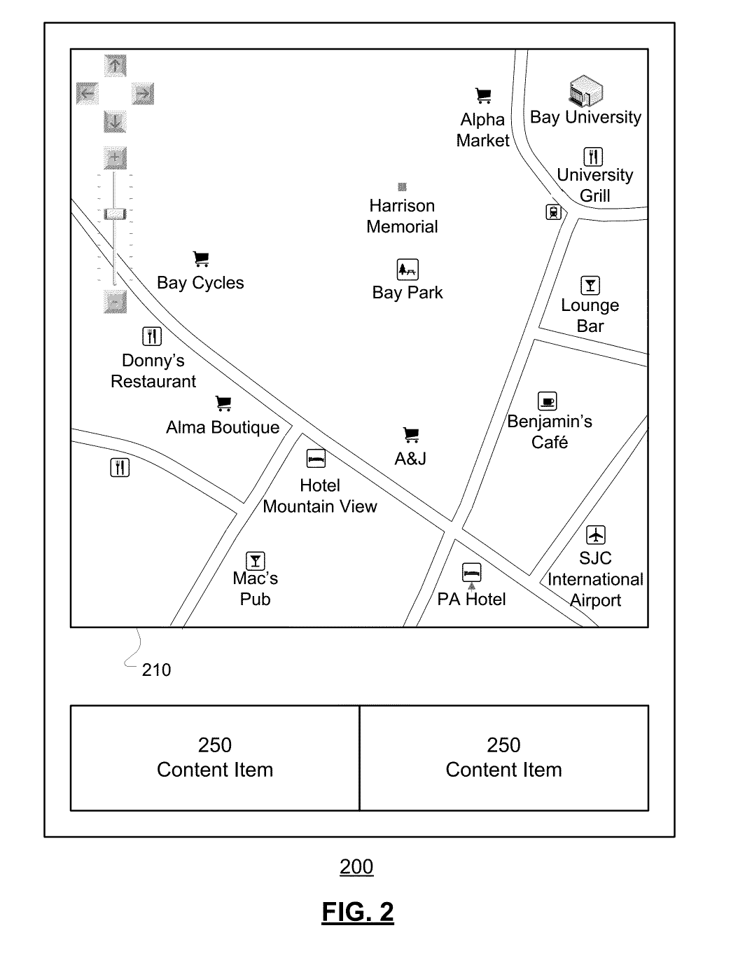

The servers 130 may be any system or device having a processor, a memory, and communications capability for generating a mapping interface that shows an image of a geographic area and transmitting the mapping interface to one or more clients 110. Each server 130 can operate on a single computing device or multiple computing devices. For example, FIG. 2 is a user interface illustrating an example mapping interface 200, in accordance with one aspect of the subject technology. The mapping interface 200 may include a geographic area in a viewport 210.

The servers 130 may also transmit one or more content items, such as content items 250, to the clients 110. In one aspect, the content items may be advertisements that are related to the geographic area in the mapping interface. Although in FIG. 2, the content items 250 are interface elements that appear in the mapping interface 200, the content items transmitted to the clients 110 may come in other forms as well. For example, they may appear as interactive interface elements on the viewport 210 (e.g., a clickable icon) or they may appear on separate user interface elements. Furthermore, the content items may be transmitted as visual media (e.g., pictures, text, video, or a combination) or other media such as an audio transmission that includes an audible message that may be played on a client device.

The content items 250 may be selected to be transmitted to the clients 110 by a content generator (e.g., an ad generator) configured to select content items from a repository of content items based on a text in a document. For example, the content generator may analyze the text in a web page document (e.g., a HyperText Markup Language (HTML) page) and identify keywords in the web page document. In some cases, any keywords found may be ranked according to, for example, how many times the keyword appears in the web page document or where the keywords are located in the web page document (e.g., in the metadata, in the title, in a heading or subheading, etc.). The content generator may then search through an index of content items and select content items to deliver to the clients based on the ranked keywords.

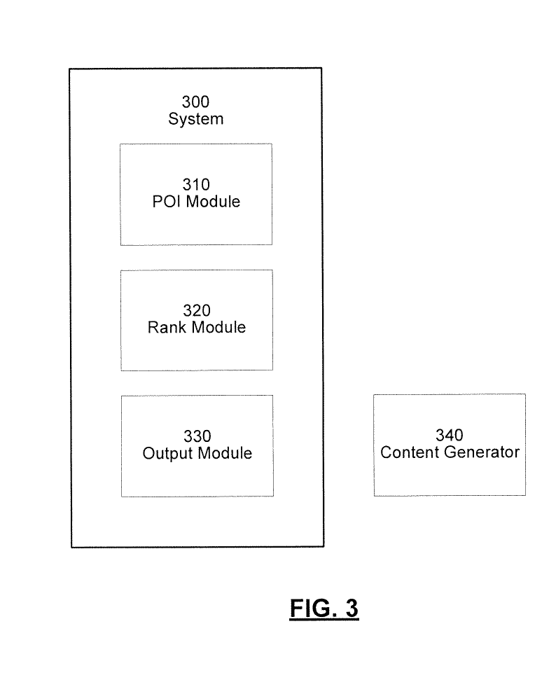

However, the content generator may not be configured to use non-textual input such as a geographic area displayed in a view port 210 in a web page or other a mapping interface 200. Accordingly, to find content items associated with a geographic area displayed in a mapping interface, the servers 130 may use a system that converts the geographic area into a format that is readable by the content generator (e.g., text). One such system is illustrated in FIG. 3.

FIG. 3 is a conceptual block diagram illustrating an example system 300 for generating a textual representation of points of interest in a geographic area, in accordance with one aspect of the subject technology. The system 300 may be hosted on one or more of the servers 130 in FIG. 1 or on a separate machine. While the system 300 is shown in one configuration in FIG. 3, in other configurations, the system 300 may include additional, alternative, and/or fewer components.

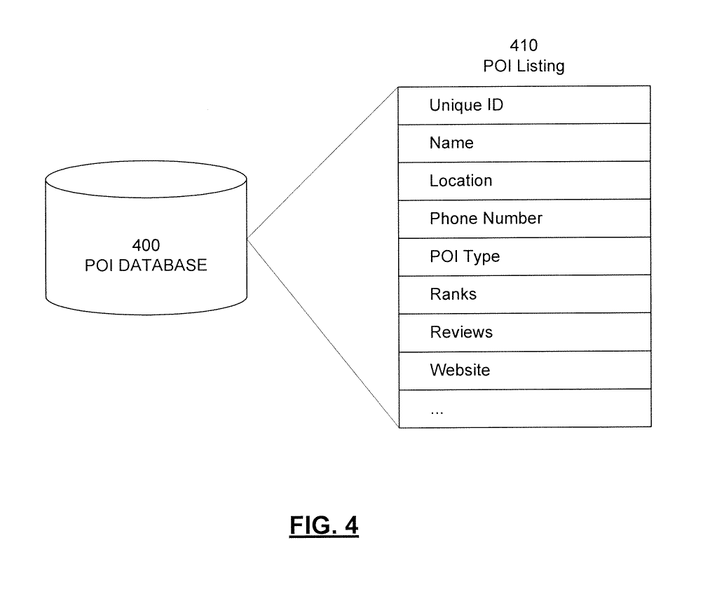

The system 300 may include a point of interest (POI) module 310, a rank module 320, and an output module 330. The POI module 310 may be configured to identify a number of points of interest that are located within or near the geographic area in the mapping interface 200. According to one aspect of the subject technology, the points of interest may be identified using a POI database such as the one shown in FIG. 4.

FIG. 4 is an illustration of an example point of interest (POI) database 400, in accordance with one aspect of the subject technology. The POI database 400 may contain information for a number of points of interest known to the system. For example, the POI database 400 may have a POI listing 410 for each point of interest known to the system. The POI listing 410 may hold various information for the point of interest such as the name of a point of interest, location coordinates for a point of interest, a phone number for the point of interest, a POI type (e.g., business, retail store, government office, restaurant, hotel, etc.), one or more rank scores assigned to the point of interest by various systems, or other information about the point of interest.

Referring back to FIG. 3, the POI module 310 may search the POI database 400 for POI listings with location coordinates that fall within the geographic area of the mapping interface 200. The rank module 320 may be configured to calculate a rank score for each of the POI listings with location coordinates that fall within the geographic area of the mapping interface 200. The POI listings may be ranked based on, for example, one or more POI types associated with the POI listings, a number of reviews, one or more ranking values assigned by other systems, the distance from the POI location coordinates to the center of the geographic area of the mapping interface, the distance from the POI location coordinates to another reference location, profile information for a user, or any other information associated with the point of interest.

The output module 330 may be configured to use the ranked POI listings and generate a textual representation of the points of interest found in the geographic area of the mapping interface 200. The textual representation may be for example, a list of POI listings, an Extensible Markup Language (XML) file, an HyperText Markup Language (HTML) file, or a file in any other format. According to one aspect of the subject technology, the POI listings in the textual representation may also be prioritized, for example, by being ordered, being associated with a ranking value, or by being associated with some other indicator of priority (e.g., HTML or XML tags).

The output module 330 may then submit the textual representation of the points of interest found in the geographic area of the mapping interface 200 to a content generator 340 so that the content generator 340 may select a number of content items (e.g., ads) to be presented to the user based on the textual representation. According to one aspect of the subject technology, the content generator 340 may be incorporated into the system 300 or located on another one of the servers 130.

The content generator 340 may be configured to select content items to be presented to the user by for example, identifying content items that are associated with one or more of the POI listings in the textual representation. According to one aspect, each POI listing may be associated with keywords and the content generator 340 may select content items to present to the user based on the keywords.

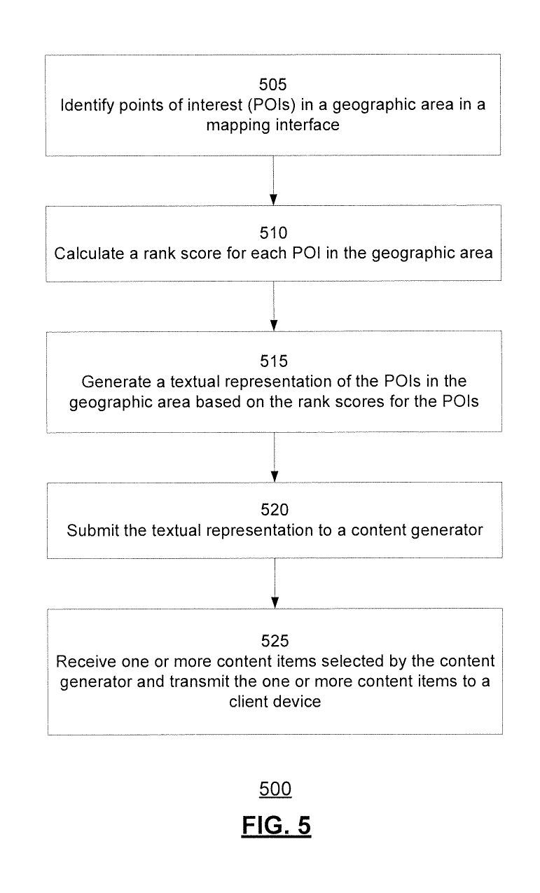

FIG. 5 is a flow chart illustrating an example process 500 for presenting content items associated with a geographic area in a mapping interface, in accordance with various aspects of the subject technology. Although the blocks in FIG. 5 are discussed with respect to the modules of system 300 illustrated in FIG. 3, the blocks are not limited to these modules. Furthermore, although the blocks are shown in one particular order, other orderings of blocks are also possible.

The process 500 may involve converting a geographic area associated with a mapping interface into a textual representation. For example, a system may receive a mapping interface containing a geographic area or simply information that may be used to define a geographic area (e.g., a set of location coordinates defining the boundaries of a geographic area).

At block 505, the POI module 310 may identify a number of points of interest (POIs) associated with the mapping interface by, for example, finding points of interest that are located inside the geographic area. According to one aspect, the POI module 310 may search a POI database 400 for points of interest that have location coordinates within the geographic area.

At block 510, the rank module 320 may calculate a rank score for each POI in the geographic area that was identified by the POI module 310. A POI's rank score may be calculated based on various factors and signals such as, but not limited to, POI types associated with the POI, reviews associated with the POI, one or more ranking values for the POI that may have been assigned by another system or process, or the distance from the POI's location coordinates to the center of the geographic area of the mapping interface.

For example, POIs of a certain type (e.g., restaurants, retail stores, hotels, etc.) may be assigned higher rank scores that POIs of other types (e.g., fire stations, bus stops, etc.) with all other factors being equal. Furthermore, POIs with location coordinates near the center of the geographic area may be assigned higher rank scores than POIs with location coordinates further away from the center of the geographic area, all other factors being equal. Similarly, POIs with more reviews or more positive reviews may be ranked higher than POIs with fewer reviews or less positive reviews.

According to one aspect, a formula that assigns various weights to the various factors and signals may be used. One example formula may be in the format provided below:

Rank Score=(w1·f1)+(w2·f2)+(w3·f3) . . .

where f1, f2, and f3 are factors and w1, w2, and w3 are weights assigned to the factors. Other formulas with different formats may also be used.

At block 515, the output module 330 may generate a textual representation of the POIs in the geographic area based on the respective rank scores of the POIs. The textual representation may include references to one or more POIs in the geographic area. For example, the textual representation may have references to all of the POIs identified by the POI module, a number of POIs with the top rank scores, or all POIs with a rank score above a threshold rank score.

According to one aspect, the references to the one or more POIs in the textual representation may be prioritized based on their respective rank scores in order to more clearly illustrate what the geographic area in the mapping interface may be depicting. For example, if the textual representation is an ordered list, the ordered list may be ordered based on the rank scores of each POI included in the textual representation or the list may also include the rank score.

In another example, if the textual representation is a document such as a HTML file, the POIs included in the textual representation may be prioritized by placing the POIs or references to the POIs in order and/or by using different delimiters. For example, references to a POI with the highest rank score may be associated with heading or paragraph HTML tags (e.g., <h1> . . . </h1>, <h2> . . . </h2>, <h3> . . . </h3> or <p1> . . . </p1>, <p2> . . . </p2>, <p3> . . . </p3>) while other references to POIs may be associated with other HTML tags (e.g., header tags, title tags, line break tags, comment tags, etc.) depending on their rank scores. Additionally, keywords, terms, or characteristics associated with of each of the POIs included in the textual representation may also be included in the document. Furthermore, in addition to HTML files or lists, the textual representation may be similarly embodied in any other document or data structure (e.g., XML files).

Once the textual representation is generated, the output module 330 may submit it to a content generator 340 (e.g., an advertisement generator) at block 520. Although the content generator 340 may be able to handle only textual input, the system 300 is able to use the content selection capabilities of the content generator 340 to select content items that are related to a mapping interface because the system has converted the contents of the mapping interface into a format that may be understood by the content generator 340.

The content generator 340 may use the textual representation of the points of interest found in the geographic area of the mapping interface to select content items (e.g., advertisements) to be presented to a user. The content generator 340 may select one or more content items to present to the user based on the textual input and transmit the selections to the system 300. At block 525, the output module 330 may receive the one or more content items selected by the content generator 340 and transmit them to a client device to be presented to a user.

According to some aspects, certain POIs may be removed from the set of identified POIs within the geographic area before they are ranked (e.g., before block 510 in FIG. 5) in order to reduce the use of computing resources and time needed to calculate a rank score for these POIs. These POIs may be removed based on, for example, the type or category of POI that they belong to (e.g., government office, airport, police station, etc.)

According to one aspect of the subject technology, content items may include advertisements, messages, public service announcements, or any other form of content that may be presented to a user of a client device.

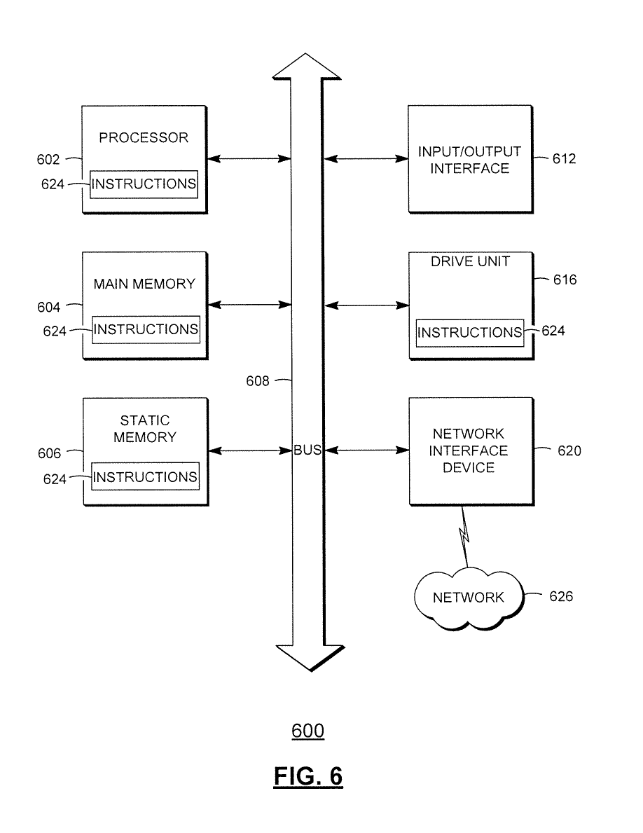

FIG. 6 is a block diagram illustrating a computer system 600 with which any of the clients, servers, computing devices, or systems described herein may be implemented. In certain aspects, the computer system 600 may be implemented using hardware or a combination of software and hardware, either in a dedicated server, or integrated into another entity, or distributed across multiple entities.

The example computer system 600 includes a processor 602, a main memory 604, a static memory 606, a disk drive unit 616, and a network interface device 620 which communicate with each other via a bus 608. The computer system 600 may further include an input/output interface 612 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 602 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 624 embodying any one or more of the methodologies or functions described herein. The instructions 624 may also reside, completely or at least partially, within the main memory 604 and/or within the processor 602 during execution thereof by the computer system 600, with the main memory 604 and the processor 602 also constituting machine-readable media. The instructions 624 may further be transmitted or received over a network 626 via the network interface device 620.

The machine-readable medium may be a single medium or multiple media (e.g., a centralized or distributed database, and/or associated caches and servers) that store the one or more sets of instructions. The machine-readable medium may comprise the drive unit 616, the static memory 606, the main memory 604, the processor 602, an external memory connected to the input/output interface 612, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Systems, methods, and machine-readable media for generating a textual representation of points of interest (POIs) in a geographic area. The system may be configured to identify a plurality of points of interest (POIs) in a geographic area displayed in a mapping interface, calculate a rank score for each POI of the plurality of POIs in the geographic area based on POI information for each POI, generate a textual representation of the mapping interface based on the rank scores for the plurality of POIs, and submit the textual representation of the geographic area to an advertisement generator.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system.

Skilled artisans may implement the described functionality in varying ways for each particular application. For example, the modules may include software instructions encoded in a medium and executed by a processor, computer hardware components, or a combination of both. The modules may each include one or more processors or memories that are used to perform the functions described below. According to another aspect, the various systems and modules may share one or more processors or memories. Various components and blocks may be arranged differently (e.g., arranged in a different order, or partitioned in a different way) all without departing from the scope of the subject technology.

It is understood that the specific order or hierarchy of blocks in the processes disclosed is an illustration of exemplary approaches. Based upon design preferences, it is understood that the specific order or hierarchy of blocks in the processes may be rearranged. Some of the blocks may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” may be used herein to mean “serving as an example or illustration.” Any aspect or design described herein as “exemplary” is not necessarily to be construed as All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A computer-implemented method for generating a textual representation of points of interest (POIs) in a geographic area, the method comprising:
identifying, using one or more computing devices, a plurality of points of interest (POIs) contained within a geographic area displayed in a mapping interface, each POI being associated with corresponding POI information;
calculating, using the one or more computing devices, a rank score to be associated with each POI of the plurality of POIs contained within the geographic area based on the POI information associated With each POI;
selecting, using the one or more computing devices, a subset of the plurality of POIs in the geographic area based on the rank scores associated with the plurality of POIs;
determining, using the one or more computing devices, a tag to associate with each POI in the selected subset based on the rank score associated with the POI wherein the tag, associated with each POI in the selected subset is varied based on variations in the rank scores of the POIs in the selected subset;
generating, using the one or more computing devices, a textual representation of the geographic area displayed in the mapping interface, wherein the textual representation comprises a reference to each POI in the selected subset and the tag associated with each POI in the selected subset; and
submitting, using the one or more computing devices, the textual representation of the geographic area to an advertisement server, wherein the advertisement server is configured to select, from an advertisement repository, at least one advertisement item associated with the geographic area.

2. The computer-implemented method of claim 1, further comprising providing for display the at least one advertisement item to a client device.

3. The computer-implemented method of claim 2, wherein the at least one advertisement item is to be displayed in the mapping interface on the client device.

4. The computer-implemented method of claim 1, wherein the at least one advertisement item comprises an audio media element.

5. The computer-implemented method of claim 1, wherein the at least one advertisement item comprises a visual media element.

6. The computer-implemented method of claim 1, wherein the POI information comprises at least one of a POI type, a number of reviews associated with the POL the distance from the POI to the center of the geographic area, and a ranking value assigned by another system.

7. The computer-implemented method of claim 1, wherein the identifying of the plurality of POIs contained within the geographic area comprises searching a POI database for POI listings with locations contained, within the geographic area.

8. (canceled)

9. The computer-implemented method of claim 1, wherein the textual representation comprises a HyperText Markup Language (HTML) document, and wherein the tag associated with each POI in the selected subset corresponds to an HTML tag, wherein different HTML, tags are associated with each POI in the selected subset based on the differing rank scores of the POIs in the selected subset.

10. The computer-implemented method of claim 9, wherein the reference to the POI in selected subset of POIs comprises key terms associated with the POI.

11. A system for generating a textual representation of points of interest (POIs) in a geographic area, the system comprising:
one or more processors; and
a machine-readable medium comprising instructions stored therein, which when executed by the one or more processors, cause the one or more processors to perform operations comprising:
identifying a plurality of points of interest (POIs) contained within a geographic area displayed in a mapping interface, each POI being associated with corresponding POI information;
calculating a rank score to be associated with each POI of the plurality of POIs contained within the geographic area based on the POI information associated with each POI;
selecting a subset of the plurality of POIs contained within the geographic area based on the rank scores associated with the plurality of POIs;
determining a tag to associate with the each POI in the selected subset based on the rank score associated with the POL wherein the tag associated with each POI in the selected subset is varied based on variations of the rank scores of the POIs in the selected subset;
generating a textual representation of the geographic area displayed in the mapping interface, wherein the textual representation comprises a reference to each POI in the selected subset and the tag associated with each POI in the selected subset; and
submitting the textual representation of the geographic area to an advertisement server, wherein the advertisement server is configured to select, from an advertisement repository, at least one advertisement item associated with the geographic area.

12. The system of claim 11, wherein the POI information associated with each POI of the plurality of POIs comprises at least one of a POI type, a number of reviews associated with the POI, the distance from the POI to the center of the geographic area, and a ranking value assigned by another system.

13. The system of claim 11, wherein the at least one advertisement item is to be transmitted to a browser to be displayed in the mapping interface.

14. The system of claim 13, wherein the at least one advertisement item comprises a visual media element.

15. The system of claim 11, wherein the identifying of the plurality of POI is contained within the geographic area displayed in the mapping interface comprises searching a POI database for POI listings with location coordinates contained within the geographic area.

16. (canceled)

17. The system of claim 11, wherein the textual representation comprises a HyperText Markup Language (HTML) document, and wherein the tag associated with each POI in the selected subset corresponds to an HTML tag, wherein different HTML Tags are associated with each POI in the selected subset based on the differing rank scores of the POIs in the selected subset.

18. A non-transitory machine-readable medium comprising instructions stored therein, which when executed by a machine, cause the machine to perform operations comprising:
identifying a plurality of points of interest (POIs), contained within a geographic area displayed in a mapping interface, each POI being associated with corresponding POI information;
calculating a rank score to be associated with each POI of the plurality of POIs contained within the geographic area based on the POI information associated with each POI;
determining a tag to associate with each POI of the plurality of POIs based on the rank score associated with the POI, wherein the tag associated with each POI of the plurality of POIs is varied based on variations in the rank scores of the plurality of POIs:
generating a textual representation of the mapping interface based on the rank scores associated with the plurality of POIs, the textual representation including the tag associated, with each POI of the plurality of POIs and
submitting the textual representation of the geographic area to an advertisement generator, wherein the advertisement generator is configured to select at least one advertisement associated with the geographic area to present to a user.

19. The machine-readable medium of claim 18, wherein the operations further comprise providing the at least, one advertisement to a client device to be displayed in the mapping interface.

20. The machine-readable medium of claim 18, wherein the textual representation comprises a HyperText Markup Language (HTML) document comprising a number of references to the plurality of POIs contained within the geographic area and wherein the tag associated with each POI of the plurality of POIs. Corresponds to an HTML tag, wherein different HTML tags are associated with each POI of the plurality of POIs based on the differing Rank scores of the plurality of POIs.
